(19) United States
(12) Patent Application Publication
(10) Pub. No.: US 2014/0036720 A1
(43) Pub. Date: Feb. 6, 2014

(54) ASSIGNING A VLAN

(71) Applicant: Hangzhou H3C Technologies Co., Ltd., Hangzhou (CN)

(72) Inventor: Hui Cao, Beijing (CN)

(73) Assignee: Hangzhou H3C Technologies Co., Ltd., Hangzhou (CN)

(21) Appl. No.: 13/960,552

(22) Filed: Aug. 6, 2013

(30) Foreign Application Priority Data
Aug. 6, 2012 (CN) 201210276881.0

(51) Int. Cl. H04L 12/24

(52) U.S. Cl. CPC H04L 41/0803
USPC 370/254

(57) ABSTRACT

In a network that comprises a first edge device and a second edge device at a site connecting the site to a core of the network, the first edge device receives, in a Hello message sent from the second edge device, information indicating a Virtual Local Area Network VLAN amongst a plurality of VLANs in the site as a preferred VLAN of the second edge device. From the Hello message sent from the second edge device, the first edge device obtains the information indicating the preferred VLAN of the second edge device. For each of the plurality of VLANs, the first edge device assigns a VLAN to the second edge device if the obtained information indicates the VLAN as the preferred VLAN of the second edge device.

### CLAIM FOR PRIORITY

The present application claims priority under 35 U.S.C 119 (a)-(d) to Chinese Patent application number 201210276881.0, filed on Aug. 6, 2012, which is incorporated by reference herein in its entirety.

### BACKGROUND

Many enterprise networks and data centres are deployed as multiple sites distributed at different geographical locations. The multiple physical sites may be interconnected. For example, the multiple physical sites may be interconnected at layer 2 by establishing layer 2 links over a core network. For example the separate physical sites may be connected using an Ethernet Virtual Interconnect (EVI) technique, which provides a layer 2 interconnection function connecting multiple EVI sites over a core network. The core network may for example be a layer 3 network. EVI establishes a virtual network amongst edge devices of each physical site using the MAC information of each EVI site so as to form a layer 2 forwarding domain. Another example is Overlay Transport Virtualisation (OTV), which links remote sites at layer 2.

At a site, there may be more than one network devices, each connected to more than one other site over the core network. A site that has more than one network devices each connecting it to the core network is referred to as “multi-homing”. In this case, each multi-homing network device may host the traffic for a portion of the Virtual Local Area Networks (VLANs) that belong to the site, to realize redundant link for data forwarding at the site and traffic sharing according to VLAN load. Here, a network device which acts as an edge device to link a site to the core network may be a router, switch, Integrated Access Device (IAD), or a variety of Metropolitan Area Network (MAN) and Wide Area Network (WAN) access devices.

### BRIEF DESCRIPTION OF THE DRAWINGS

FIG. 1 is an example of a communication network deployed across multiple sites;

FIG. 2 is a flow diagram of an example of a method for use at an EVI site to allocate VLAN;

FIG. 3 is an example format of a preferred VLAN sub-TLV;

FIG. 4 is an example of a network device; and

FIG. 5 is another example of a network device.

### DETAIL DESCRIPTION

In an example, for a network comprising a first edge device and a second edge device at a site connecting the site to a core of the network, the first edge device receives, in a Hello message sent from the second edge device, information indicating a VLAN amongst a plurality of VLANs as a preferred VLAN of the second edge device. From the Hello message sent from the second edge device, the first edge device obtains the information indicating the preferred VLAN of the second edge device. For each of the plurality of VLANs, the first edge device assigns a VLAN to the second edge device if the obtained information indicates the VLAN as the preferred VLAN of the second edge device.

The preferred VLAN of the second edge device may change from time to time. The preference may depend, for example, on the performance of the second edge device with respect to other network or edge devices at the site (for instance the second edge device may be capable of handling more traffic), or the immediate load sharing requirement of the site (for instance some VLANs may require more resources compared to others). According to the example, the first edge device is notified of a preferred VLAN of the second edge device, so that the first edge device may assign the plurality of VLANs at the site according to the preferred VLAN of the second edge device. Since the assignment of a VLAN by the first edge device to the second edge devise is based on the information received from the second edge device indicating a VLAN as a preferred VLAN, compared to a case where the allocation of VLANs to an edge device is fixed and cannot be easily changed, the present example allows VLANs of a site to be divided amongst a plurality of edge devices in a dynamic and flexible manner, thus the flexibility and controllability of the allocation of VLANs may be improved.

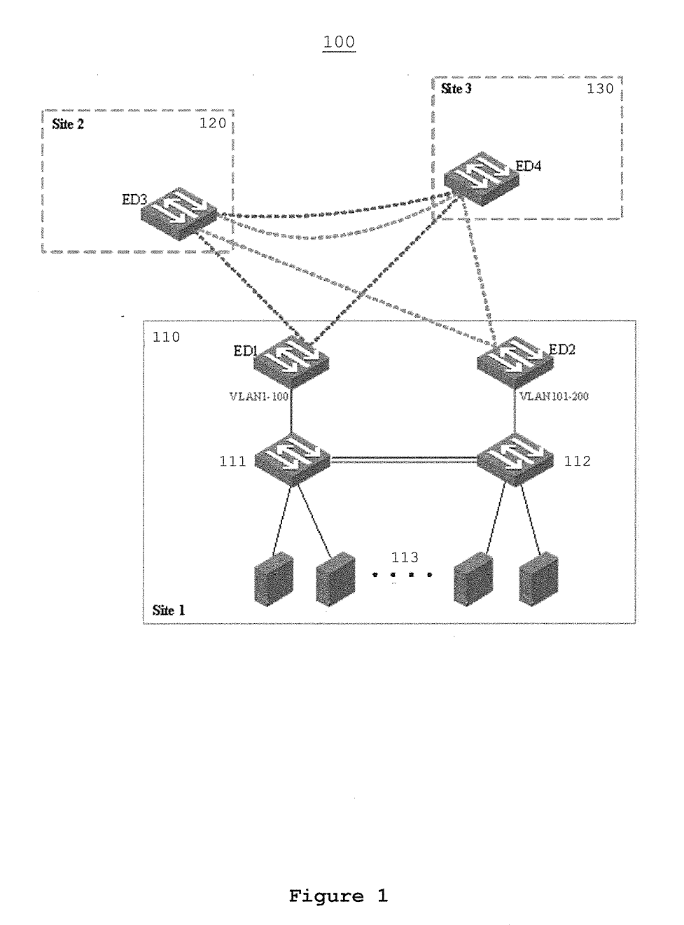

An example of a communication network deployed across multiple sites is shown schematically in FIG. 1. In the example, the network 100 comprises three sites—Site 1 110, Site 2 120 and Site 3 130. These sites may for example be EVI sites connected using an EVI technique. More or fewer sites may be deployed as required. At the edge of Site 1 are two edge devices ED1 (first network device) and ED2 (second network device), which connect Site 1 to Site 2 and Site 3 via edge devices ED3 and ED4 respectively over a core network. At Site 1, each of the edge devices ED1 and ED2 is respectively connected to switches 111 and 112, which in turn are connected to a plurality of nodes 113. Although switches 111 and 112 are provided between the edge devices ED1 and ED2 and the nodes 113 in the present example, the edge devices ED1 and ED2 may alternatively be connected directly to the plurality of nodes 113.

In the example, the multi-homing edge devices ED1 and ED2 at Site 1 may communicate with each other using a link state protocol, for example an IS-IS protocol or more specifically an EVI IS-IS protocol. By sending Hello messages, the edge devices ED1 and ED2 may elect a designated edge device to perform the function of allocating each of VLAN1 to VLAN200 of Site 1 to one of the edge devices ED1 and ED2, thus enabling traffic load sharing by dynamically and flexibly dividing traffic between the edge devices on a VLAN basis. Although only two edge devices are provided to the Site 1 in the example, more than two edge devices may be provided to a site as required. It should be noted that the number of VLANs may be different from 200.

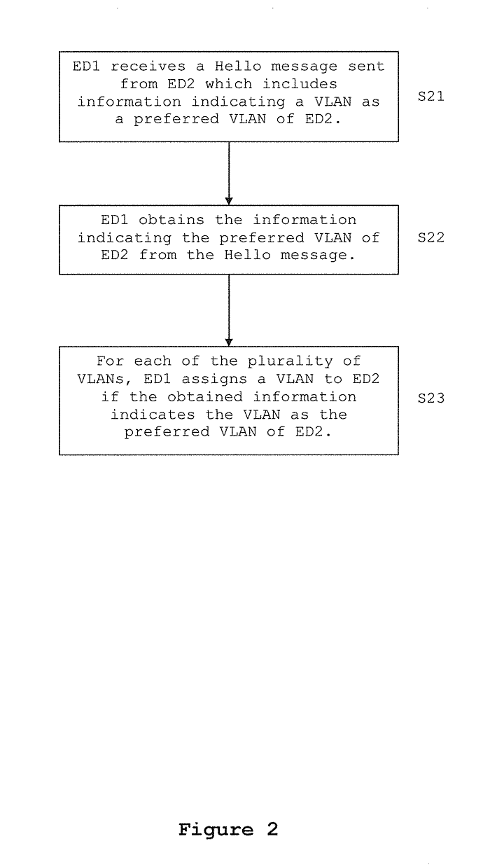

An example of a method for allocating VLAN load within a site such as an EVI site is shown in FIG. 2. The configuration of network 100 in FIG. 1 is used here for the purpose of illustration. In the example, it may be assumed that ED1 is elected to be the designated edge device of Site 1.

At block S21, ED1 receives a Hello message sent from ED2, which includes information indicating a VLAN amongst VLAN1 to VLAN200 as a preferred VLAN of ED2.

The preferred VLAN of an edge device may be set by a network manager based on performance or networking requirements. An edge device may indicate its preferred VLAN in an IS-IS Hello message. For example, the edge device may additionally include in the IS-IS Hello message a preferred VLAN sub-TLV, for instance, in the Multi-Topology aware Port Capability TLV of the IS-IS Hello message. The edge device may then indicate its preferred VLAN in the preferred VLAN sub-TLV. The edge device may indicate one or multiple (continuous range or discrete) VLAN in the Hello message as its preferred VLAN.

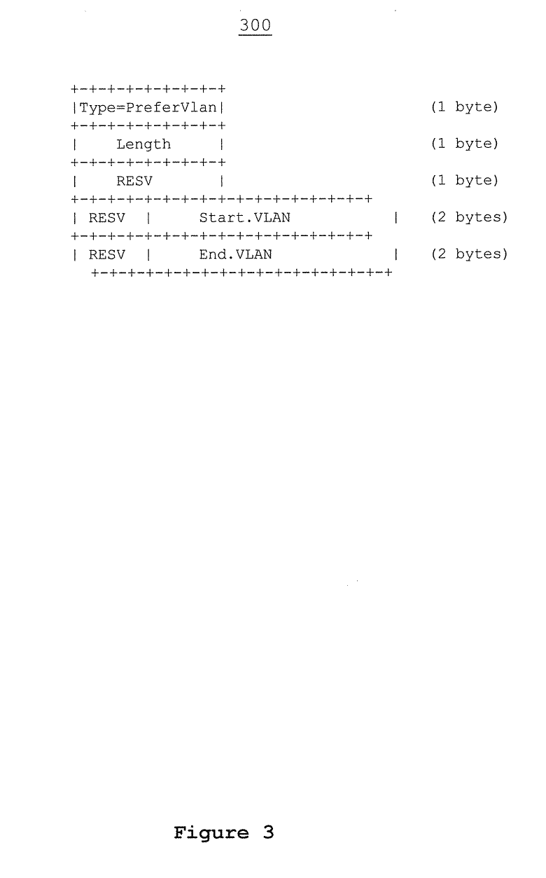

An example format of a preferred VLAN sub-TLV is shown in FIG. 3. In the example, preferred VLAN sub-TLV 300 includes a RESV field currently not in use but reserved for future use, for example, for indicating a priority. Preferred VLAN sub-TLV 300 further includes Start.VLAN for indicating a start VLAN number, and End.VLAN for indicating an end VLAN number—together, Start.VLAN and End.VLAN indicate one or more preferred VLAN in the form of a VLAN number range. If required, more than one preferred VLAN sub-TLV may be included in a Hello message.

Referring again to FIG. 2, at block S22, ED1 obtains the information indicating the preferred VLAN of ED2 from the Hello message received from ED2. In particular, ED2 may indicate one or more preferred VLAN by including one or more preferred VLAN sub-TLV in the Hello message.

At block S23, ED1 assigns a VLAN amongst VLAN1 to VLAN200 to ED2 if the information obtained from the Hello message indicates the VLAN as a preferred VLAN of ED2. If the information obtained from the Hello message from ED2 indicates more than one VLAN, for example VLAN101 to VLAN200, as preferred VLANs, ED1 assigns to ED2 all preferred VLANs indicated in the Hello message from ED2.

In the example of FIG. 1, ED1 may indicate in a Hello message VLAN1 to VLAN100 as its preferred VLANs. In this case ED1 assigns VLAN1 to VLAN100 to ED1, and assigns VLAN101 to VLAN200 to ED2. In another example, ED1 may indicate in a Hello message odd number VLANs as its preferred VLANs, while ED2 may indicate in a Hello message even number VLANs as its preferred VLANs. In this case ED1 assigns VLAN1, VLAN3, VLAN5, VLAN7, . . . to ED1, and assigns VLAN2, VLAN4, VLAN6, VLAN8, . . . to ED2. By implementing a VLAN assignment method as described in the examples above, flexible and controllable load sharing based on VLAN may be achieved.

If both ED1 and ED2 indicate a particular VLAN, for example VLAN100, as their preferred VLAN, or if neither of the edge devices indicate VLAN100 as their preferred VLAN, ED1 then assigns VLAN100 according to a predetermined distribution principle. The predetermined distribution principle may for example be a principle of equal distribution which compares the VLAN traffic already hosted by each edge device and assigns the VLAN to an edge device with the lightest load, or any other principle deemed desirable by the system manager.

In an example, the edge devices ED1 and ED2 may further indicate the priority associated with each preferred VLAN in their respective Hello messages, for example by using the RESV field in the preferred VLAN sub-TLV 300. In this case, ED1 obtains the one or more preferred VLAN indicated in the Hello messages together with the priority associated with each preferred VLAN from the Hello messages. If both ED1 and ED2 indicate a particular VLAN, for example VLAN100, as their preferred VLAN, ED1 compares the priority associated with VLAN100 as indicated in the received Hello messages, and assigns VLAN100 to the edge device which indicates in its Hello message the higher priority associated with VLAN100. If both ED1 and ED2 indicate the same priority associated with VLAN100, ED1 assigns VLAN100 to either ED1 or ED2 according to a predetermined distribution principle.

In the example of FIG. 1, Site 1 comprises two edge devices ED1 and ED2. In another example, an EVI site may comprise more than two edge devices ED1, ED2, ED3, . . . , EDn (not shown). In this example, the edge devices ED1 to EDn may elect a designated edge device, for instance ED1. Each of the edge devices ED1 to EDn may indicate in a Hello message its respective one or more preferred VLAN, for example by including one or more preferred VLAN sub-TLV in the Hello message. Designated edge device ED1 obtains the information indicating the preferred VLANs of each of the edge devices ED1 to EDn, and assigns the respective preferred VLANs to each of ED1 to EDn. If more than one edge devices indicate a particular VLAN as their preferred VLAN, or if none of the edge devices indicate the particular VLAN as their preferred VLAN, ED1 then assigns the particular VLAN according to a predetermined distribution principle.

In another example, the edge devices ED1 to EDn may further indicate the priority associated with each preferred VLAN in their respective Hello messages, for example by using the RESV field in the preferred VLAN sub-TLV 300. In this example, ED1 obtains the one or more preferred VLAN indicated in the Hello messages together with the priority associated with each preferred VLAN from the Hello messages. If more than one edge devices indicate a particular VLAN as their preferred VLAN, ED1 compares the priority associated with the particular VLAN as indicated in the received Hello messages, and assigns the particular VLAN to an edge device which indicates in its Hello message the highest priority associated with the particular VLAN. Amongst the more than one edge devices (five for example) indicating the particular VLAN as their preferred VLAN, if two or more edge devices (three for example) indicate the same level of priority associated with the particular VLAN that is the highest amongst the five edge devices, ED1 assigns the particular VLAN to one of the three edge devices according to a predetermined distribution principle.

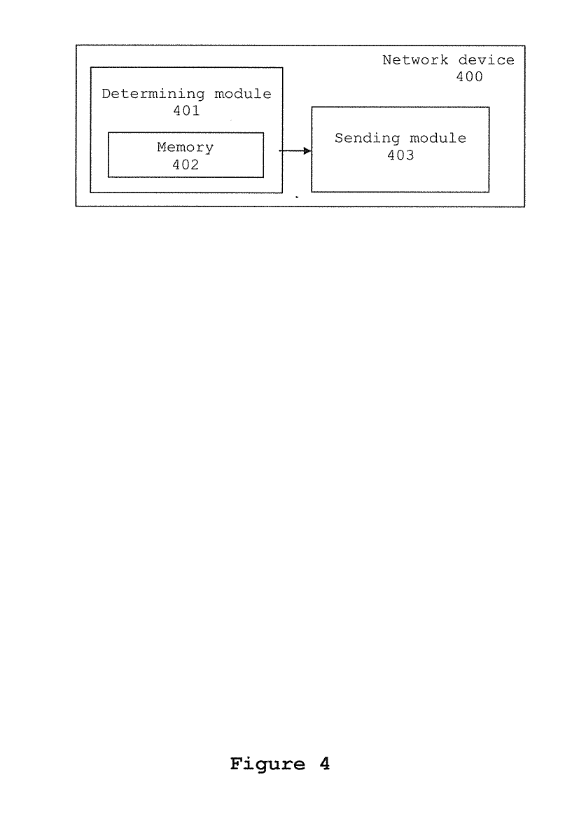

An example of an edge device that may perform the function of the multi-homing edge device ED2 is shown in FIG. 4. In the example, the edge device 400 is deployed at a site connecting the site to the core network, and comprises a determining module 401 and a sending module 403. The determining module 401 is configured to determine a VLAN amongst a plurality of VLANs in the site as a preferred VLAN of the edge device. The sending module 403 is configured to include in a Hello message information indicating the preferred VLAN of the edge device 400 determined by the determining module 401, and to then send the Hello message to another edge device of the site. The another edge device may for example be the multi-homing edge device ED1, elected by the edge devices of the site to be a designated edge device. The sending module 403 may include the information indicating a VLAN as a preferred VLAN in the form of a preferred VLAN sub-TLV.

In an example, the determining module 401 may be further configured to determine a priority associated with the preferred VLAN of the network device, and the sending module 403 may be further configured to include in the Hello message an indication of the priority determined by the determining module 401. The sending module 403 may include the indication of a priority associated with the preferred VLAN in the RESV field of the preferred VLAN sub-TLV.

In an example, the edge device may further include a memory 402 integrated in the determining module 401 or provided separately. The memory may be used for storing the preferred VLAN of the edge device and the priority associated with the preferred VLAN determined by the determining module 401, and the sending module 403 access the memory 402 to obtain information of the preferred VLAN and the associated priority.

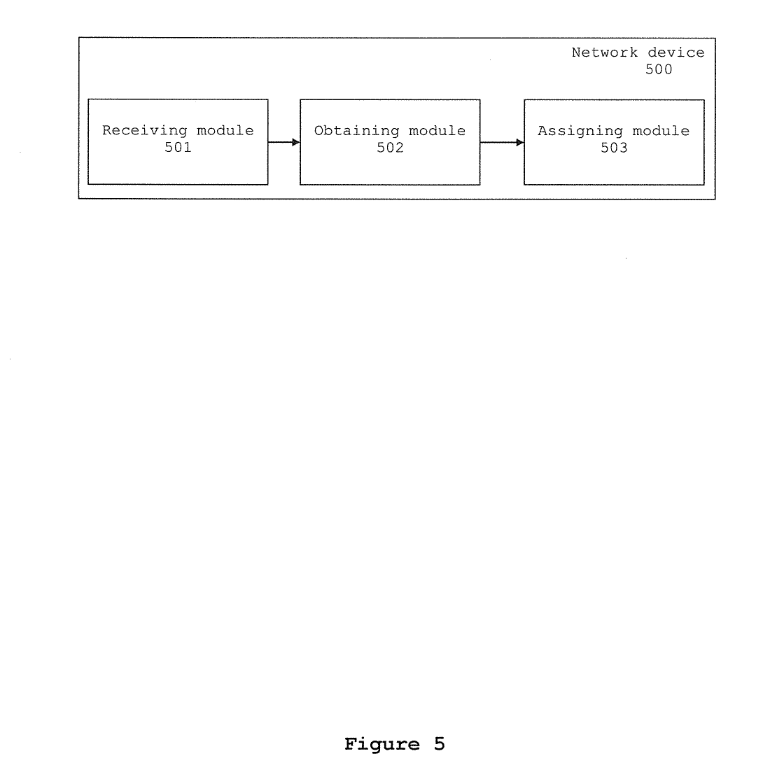

An example of a edge device that may perform the function of the multi-homing edge device ED1 is shown in FIG. 5. In the example, the edge device 500 is deployed at a site connecting the site to the core network, and comprises a receiving module 501, an obtaining module 502 and an assigning module 503.

The receiving module 501 is configured to receive a Hello message sent from another edge device at the site containing information indicating a VLAN, amongst a plurality of VLANs in the site, as a preferred VLAN of the another edge device.

The obtaining module 502 is configured to obtain the information indicating the preferred VLAN of the another edge device from the Hello message sent from the another edge device.

The assigning module 503 is configured to assign a VLAN to the another edge device if the obtained information indicates the VLAN as the preferred VLAN of the another edge device.

The edge device 500 may for example be the multi-homing edge device ED1, which is elected by the edge devices of the site to be a designated edge device. The another edge device may for example be the multi-homing edge device ED2.

In the example, if both the edge device, for instance ED1, and the another edge device, for instance ED2, indicate a particular VLAN, for example VLAN100, as their preferred VLAN, or if neither of the edge devices indicate VLAN100 as their preferred VLAN, ED1 then assigns VLAN100 according to a predetermined distribution principle.

In an example, the edge devices ED1 and ED2 may further indicate the priority associated with each preferred VLAN in their respective Hello messages, for example by using the RESV field in the preferred VLAN sub-TLV 300. In this case, the obtaining module 502 is configured to obtain the one or more preferred VLAN indicated in the Hello messages together with the priority associated with each preferred VLAN from the Hello messages. If both edge devices ED1 and ED2 indicate a particular VLAN, for example VLAN100, as their preferred VLAN, the assigning module 503 is further configured to compare the priority associated with VLAN100 as indicated in the received Hello messages, and assigns VLAN100 to the edge device which indicates in its Hello message the higher priority associated with VLAN100. If both edge devices ED1 and ED2 indicate the same priority associated with VLAN100, the assigning module 503 is configured to assign VLAN100 to either ED1 or ED2 according to a predetermined distribution principle.

In an example where a site comprises more than two edge devices, for instance edge devices ED1, ED2, ED3, . . . , EDn, the edge devices ED1 to EDn may elect a designated edge device ED1. The receiving module 501 receives from each of the edge devices ED1 to EDn a respective Hello message including information indicating a preferred VLAN of each edge device. The obtaining module 502 obtains the information indicating the preferred VLANs of each of the edge devices ED1 to EDn, and the assigning module 503 assigns the respective preferred VLANs to each of ED1 to EDn.

Although the flow diagram described above show a specific order of execution, the order of execution may differ from that which is depicted.

The above examples can be implemented by hardware, software, firmware, or a combination thereof. For example, the various methods and functional modules described herein may be implemented by a processor (the term processor is to be interpreted broadly to include a CPU, processing unit, ASIC, logic unit, or programmable gate array etc.). The methods and functional modules may all be performed by a single processor or divided amongst several processors. The methods and functional modules may be implemented as machine readable instructions executable by one or more processors, hardware logic circuitry of the one or more processors, or a combination thereof. Further, the teachings herein may be implemented in the form of a software product, the computer software product being stored in a storage medium and comprising a plurality of instructions for making a computer device (e.g. a personal computer, a server or a network device such as a router, switch, access point etc.) implement the method recited in the examples of the present disclosure.

It should be understood that embodiments of the method and devices described above are implementation examples only, and do not limit the scope of the invention. Numerous other changes, substitutions, variations, alternations and modifications may be ascertained by those skilled in the art, and it is intended that the present disclosure encompass all such changes, substitutions, variations, alterations and modifications as falling within the spirit and scope of the appended claims.

1. A method for a network comprising a first edge device and a second edge device at a site connecting the site to a core of the network, the method comprising:
the first edge device receiving, in a Hello message sent from the second edge device, information indicating a Virtual Local Area Network VLAN amongst a plurality of VLANs in the site as a preferred VLAN of the second edge device;
the first edge device obtaining the information indicating the preferred VLAN of the second edge device from the Hello message sent from the second edge device; and
for each of the plurality of VLANs, the first edge device assigning a VLAN to the second edge device if the obtained information indicates the VLAN as the preferred VLAN of the second edge device.

2. The method of claim 1 wherein the site comprises a plurality of second edge devices, the first edge device receives, in a Hello message sent from each of the plurality of second edge devices, information indicating a VLAN amongst the plurality of VLANs as a preferred VLAN of a respective one of the plurality of second edge devices, obtains the information indicating the preferred VLAN of each of the plurality of second edge devices, and assigns the VLAN to a present second edge device of the plurality if the obtained information indicates the VLAN as the preferred VLAN of the present second edge device.

3. The method of claim 1 wherein the first edge device is a designated edge device elected by all edge devices at the site.

4. The method of claim 2 wherein, in a case where the information obtained from more than one of the plurality of second edge devices indicates the VLAN as the preferred VLAN, the first edge device assigns the VLAN to one of the more than one second edge devices according to a predetermined distribution principle, or, in a case where none of the information obtained from the plurality of second edge devices indicates the VLAN as the preferred VLAN, the first edge device assigns the VLAN to one of the plurality of second edge devices according to the predetermined distribution principle.

5. The method of claim 2 further comprising:
the first edge device receiving, in the Hello message sent from each of the plurality of second edge devices, an indication of a priority associated with the preferred VLAN of a respective one of the plurality of second edge devices;
the first edge device obtaining the indication of the priority associated with the preferred VLAN of each of the plurality of second edge devices; and
the first edge device comparing, in a case where the information obtained from more than one second edge devices of the plurality indicate the VLAN as the preferred VLAN, the priority associated with the VLAN indicated in the Hello message from each of the more than one second edge devices, and assigning the VLAN to the second edge device from which the Hello message indicates the highest priority.

6. The method of claim 5 wherein, in a case where the information obtained from more than one second edge devices of the plurality indicate the VLAN as the preferred VLAN and the Hello message from each of the more than one second edge devices indicates the same priority associated with the preferred VLAN, the first edge device assigns the VLAN to one of the more than one second edge devices according to a predetermined distribution principle.

7. A first edge device for a network comprising the first edge device and a second edge device at a site connecting the site to a core of the network, the first edge device comprising:
a receiving module to receive a Hello message sent from the second edge device containing information indicating a Virtual Local Area Network VLAN, amongst a plurality of VLANs in the site, as a preferred VLAN of the second edge device;
an obtaining module to obtain the information indicating the preferred VLAN of the second edge device from the Hello message sent from the second edge device; and
an assigning module to assign, for each of the plurality of VLANs, a VLAN to the second edge device if the obtained information indicates the VLAN as the preferred VLAN of the second edge device.

8. The first edge device of claim 7, in a case where the site comprises a plurality of second edge devices, the receiving module is to receive a Hello message sent from each of the plurality of second edge devices containing information indicating a VLAN amongst the plurality of VLANs as a preferred VLAN of a respective one of the plurality of second edge devices, the obtaining module is to obtain the information indicating the preferred VLAN of each of the plurality of second edge devices, and the assigning module is to assign the VLAN to a present second edge device of the plurality if the obtained information indicates the VLAN as the preferred VLAN of the present second edge device.

9. The first edge device of claim 7 wherein the first edge device is a designated edge device elected by all edge devices in the EVI site.

10. The first edge device of claim 8 wherein, in a case where the obtaining module obtains from more than one of the plurality of second edge devices information indicating the VLAN as the preferred VLAN, the assigning module is to assign the VLAN to one of the more than one second edge devices according to a predetermined distribution principle, or, in a case where the obtaining module obtains from none of the plurality of second edge devices information indicating the VLAN as the preferred VLAN, the assigning module is to assign the VLAN to one of the plurality of second edge devices according to the predetermined distribution principle.

11. The first edge device of claim 8 wherein:
the Hello message sent from each of the plurality of second edge devices further contains an indication of a priority associated with the preferred VLAN of a respective one of the plurality of second edge devices;
the obtaining module is to obtain the indication of the priority associated with the preferred VLAN of each of the plurality of second edge devices; and
the assigning module is to compare, in a case where the obtaining module obtains from more than one second edge devices of the plurality information indicating the VLAN as the preferred VLAN, the priority associated with the VLAN indicated in the Hello message from each of the more than one second edge devices, and to assign the VLAN to the second edge device from which the Hello message indicates the highest priority.

12. The first edge device of claim 11 wherein, in a case where the obtaining module obtains from more than one second edge devices of the plurality information indicating the VLAN as the preferred VLAN and the Hello message from each of the more than one second edge devices indicates the same priority associated with the preferred VLAN, the assigning module is to assign the VLAN to one of the more than one second edge devices according to a predetermined distribution principle.

13. An edge device for a network comprising the edge device and another edge device at a site connecting the site to a core of the network, the edge device comprising:
a determining module to determine a Virtual Local Area Network VLAN amongst a plurality of VLANs in the site as a preferred VLAN of the edge device; and
a sending module to include in a Hello message information of the preferred VLAN of the edge device determined by the determining module, and to send the Hello message to the another edge device of the site.

14. The edge device of claim 11 wherein the determining module is further to determine a priority associated with the preferred VLAN of the edge device, and the sending module is further to include in the Hello message an indication of the priority determined by the determining module.

15. A method for a network comprising a first edge device and a plurality of second edge devices at an Ethernet Virtual Interconnect EVI site, each of the first and second edge devices being a multi-homing edge device connecting the EVI site to a core of the network, the method comprising:
the first edge device receiving, in a Hello message sent from each of the plurality of second edge devices, information indicating a Virtual Local Area Network VLAN amongst a plurality of VLANs in the EVI site as a preferred VLAN of a respective one of the plurality of second edge devices;
the first edge device obtaining the information indicating the preferred VLAN of each of the plurality of second edge devices from the respective Hello message sent from each of the plurality of second edge devices; and
for each of the plurality of VLANs, the first edge device assigning a VLAN to a present second edge device of the plurality if the obtained information indicates the VLAN as the preferred VLAN of the present second edge device,
wherein the first edge device is a designated edge device elected by all edge devices in the EVI site.
